(19) United States
(12) Patent Application Publication
(10) Pub. No.: US 2010/0274604 A1
(43) Pub. Date: Oct. 28, 2010

(54) Position Based Operational Tracking Of A Transport Refrigeration Unit

(76) Inventor: Benjamin Carter Crilly, Petaluma, CA (US)

Correspondence Address: Ashok Tankha, 36 Greenleigh Drive, Sewell, NJ, 08080, US

(21) Appl. No.: 12/430,055

(22) Filed: Apr. 24, 2009

(51) Int. Cl. G06Q 10/00; G08B 21/00; B60H 1/32; F25B 19/00; F25B 49/00; G06F 19/00; G06F 15/16

(52) U.S. Cl. 705/7; 340/431; 62/239; 62/231; 62/127; 701/33; 709/203; 903/903

(57) ABSTRACT

Disclosed herein is a method and system for position based tracking of operation of a transport refrigeration unit (TRU). A client application is provided on a data logger connected to the TRU. The client application determines position data of the TRU with respect to predefined geographic zones, acquires operational data of the TRU when the TRU is within the predefined geographic zones, and communicates with a remote server via wired communication or wireless communication. When the TRU arrives at a new facility that has not been defined as a geographic zone that the TRU operates in, a new geographic zone for the new facility is defined. The client application notifies a user of the TRU regarding control of the TRU's operating conditions based on the position data and the operational data. The control of the operating conditions ensures compliance of the user with TRU airborne toxic control measures.

### BACKGROUND

The method and system disclosed herein, in general, relates to tracking the activity of a unit on a vehicle. More particularly, the method and system disclosed herein relates to position based tracking of operation of a transport refrigeration unit (TRU).

Trucks equipped with dedicated refrigeration units, herein referred to as “transport refrigeration units” (TRUs), are commonly used to transport goods that need to be maintained during transit at sub-ambient temperatures. Conventional TRUs are typically powered by a dedicated diesel engine. Conventional TRUs retrofitted to run on diesel power and on standby electric power or hybrid electric power qualify to meet the State of California's ultra low emission TRU (ULETRU) performance standard as alternative technology only if they comply with the in-use performance standards of the TRU airborne toxic control measure (ATCM) as an alternative technology. The standards are recited under Title 13, California Code of Regulations, section 2477, subsection (e)(1)(A)3.a. E/S-equipped TRUs and hybrid electric TRUs are alternative technologies that qualify to meet the ULETRU in-use performance standard only if the TRU is not operated under diesel engine power while at a facility, except during an emergency. The TRU ATCM also applies to TRU generator sets. TRU generator sets are designed and used to provide electric power to electrically driven refrigeration units of any type.

To qualify, non compliant diesel engine operation of the TRU must be eliminated at all facilities, with narrow exceptions such as during an emergency, during normal ingress and egress yard maneuvering, and to make short duration stops to unload refrigerated goods at restaurants, grocery and convenience stores, and similar facilities provided the delivery stay is not more than 30 minutes, and no more than two TRUs are present at a time. There is a need for maintaining a robust recordkeeping system to demonstrate that diesel engine operation is eliminated while the TRU is at a facility. The records to be maintained to demonstrate compliance comprise gate time stamps or logs at each facility gate entry and exit during arrival and departure, engine hour meter readings at each entry and exit, E/S hour meter readings at each entry and exit, diesel fuel consumption records for each unit, temperature compliance of the TRU with regard to the transported goods, etc. Reporting to the California Air Resource Board (ARB) is not required; but, records going back three years would need to be made available to ARB inspectors to demonstrate compliance.

TRUs can be operated using diesel power or electrical power. The duration of operation of the TRU when diesel power is used is called diesel hour and the duration of operation of the TRU when the electrical power is used is called electric hour. Generally, all TRUs have a 12 volt high or low signal for logging electric hours and diesel hours. Although all TRUs have hour meters, it is not usually possible to determine the power supply the TRU is running on unless the driver makes a manual entry in the driver's log. Therefore, there is a need for position based hour meter tracking of the operation of the TRU, i.e., a system for automatically tracking the location of the TRU and logging the use of the diesel engine or the electric standby system for powering the TRU. Moreover, the data logged by the TRU users, for example, regarding their arrival at and departure from a facility, or the duration of usage of the diesel or electric modes of operation while at a facility may be inaccurate. The ARB requires logs maintained for at least 3 years to be made available in order to demonstrate compliance with the ATCM. Potential loss of logged data is also another issue that the TRU users have to contend with.

Hence, there is a need for a method and system that automatically logs the duration and TRU positions where the diesel engine operation or electric standby unit operation is used, accurately tracks and logs data from each TRU either automatically or with minimal user intervention, and maintains the logged data in a remote server that the TRU users and the ARB can access with ease. Furthermore, there is a need for a method and system that ensures compliance of a user of the TRU with the TRU ATCM.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the above stated needs for automatically logging positions of a transport refrigeration unit (TRU) and corresponding hour meter tracking, i.e., where the diesel engines or electric modes are used, accurately tracking and logging data comprising, for example, hour meter readings, temperature distribution in the TRU, performance of the diesel particulate trap, usage of diesel fuel, time period during which the TRU was running on diesel and on stand-by electric power, etc. from each TRU either automatically or with minimal user intervention, and for maintaining the logged data in a remote server that the TRU users and the California Air Resource Board (ARB) can access with ease. The method and system disclosed herein enables position based tracking of operation of the TRU.

The TRU is provided with a data logger. A client application is provided on the data logger connected to the TRU. The TRU user presses one of multiple control buttons provided on the data logger to activate the client application. A global positioning system (GPS) tracking device on the TRU tracks the position of the TRU at each facility and communicates the position to the client application. The client application determines the position data of the TRU with respect to multiple predefined geographic zones stored on the client application of the data logger. The client application checks position data of the TRU to determine if the TRU is within one of the predefined geographic zones defined for a facility, by means of geographic fencing. If the TRU is at a new facility, the client application transmits the position data of the new facility to the remote server. The remote server defines a new geographic zone for the new facility and stores the new geographic zone in a first database comprising the predefined geographic zones. The client application communicates with the remote server via, for example, the facility's wi-fi (802.11g) connection to update the predefined geographic zones stored on the client application of the data logger with the new geographic zone.

The client application acquires operational data of the TRU when the TRU is within the predefined geographic zones. The operational data comprises, for example, time of switching between a first mode of operation and a second mode of operation of the TRU. The first mode of operation of the TRU is, for example, a diesel mode and the second mode of operation of the TRU is, for example, an electric mode. The operational data further comprises, for example, duration of operation of the TRU in each of the first mode of operation and the second mode of operation, duration of stop of the TRU at the facility, and data obtained from multiple sensors located within the TRU. The readings of the duration of operation of the TRU in each of the first mode of operation and the second mode of operation are herein referred to as hour meter readings. Data obtained from the sensors comprises, for example, temperature distribution within the TRU at predetermined points in time, performance of the diesel particulate trap located in the TRU, usage of diesel fuel by the TRU, etc. The operational data is transmitted to the remote server when the client application on the TRU has access to a communication network. The client application communicates with the remote server via wired communication, wireless communication, or a combination thereof. The wireless communication is performed via, for example, a wi-fi (802.11g) protocol or a general packet radio service (GPRS) protocol.

The remote server stores the operational data in the first database on the remote server. If the client application does not have access to the communication network, the client application stores the operational data on a storage card of the data logger until the client application gains access to the communication network to update the operational data to the first database on the remote server.

The client application constantly seeks to establish a wi-fi connection for transmitting the position data and the operational data to the remote server. The position data and the operational data from the data logger are uploaded when the wi-fi connection is established. The client application is authenticated prior to establishing the wi-fi connection. The user also configures user preferences on the client application. The client application selects a mode of communicating with the remote server based on the user preferences.

The client application notifies the TRU user regarding control of operating conditions of the TRU based on the position data and operational data. The client application notifies the user, for example, when the duration of stop at a facility exceeds an allowable duration of stop. Furthermore, the client application notifies the user to switch from the first mode of operation to the second mode of operation when the duration of operation in the first mode of operation exceeds an allowable duration of operation. Control of the operating conditions of the TRU based on the position data and the operational data ensures compliance of the TRU user with the TRU airborne toxic control measures.

The first database, for example, a structured query language (SQL) database also communicates data with the client application on a first TRU regarding the position of other TRUs present at the same facility at the same time as the first TRU. When the client application on the first TRU is notified regarding the presence of more than two TRUs at the same location as the first TRU, the client application on the first TRU checks to determine if the first TRU is operating under diesel power and starts the timer for logging the diesel hours if the first TRU is using diesel power. The user of the first TRU is notified to switch the diesel mode of operation of the first TRU to electric standby mode of operation, even if duration of the diesel mode of operation of the first TRU is less than the allowable duration of operation, to ensure compliance of the first TRU with the TRU ATCM.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method for position based tracking of operation of a transport refrigeration unit.

FIG. 2 exemplarily illustrates a system for position based tracking of operation of a transport refrigeration unit.

FIGS. 3A-3C exemplarily illustrate a flowchart comprising the steps involved in tracking the operation of the transport refrigeration unit and alerting the user regarding control of the operating conditions.

FIG. 4 exemplarily illustrates a user of a transport refrigeration unit communicating with a remote server from different communication networks for uploading stored data.

FIG. 5 exemplarily illustrates data storage and transmission while a transport refrigeration unit enters and exits a predefined geographic zone.

FIG. 6 exemplarily illustrates records in a first database of a remote server corresponding to tracking a mode of operation of a transport refrigeration unit at two facilities.

FIG. 7 exemplarily illustrates a geographic zone having multiple loading and unloading docks.

FIG. 8 exemplarily illustrates tracking of diesel hour meter of TRUs when more than one TRU is present at a grocery store at the same time.

### DETAILED DESCRIPTION OF THE INVENTION

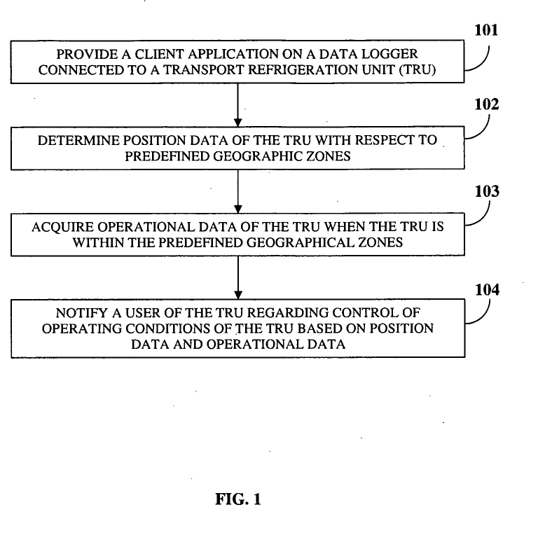

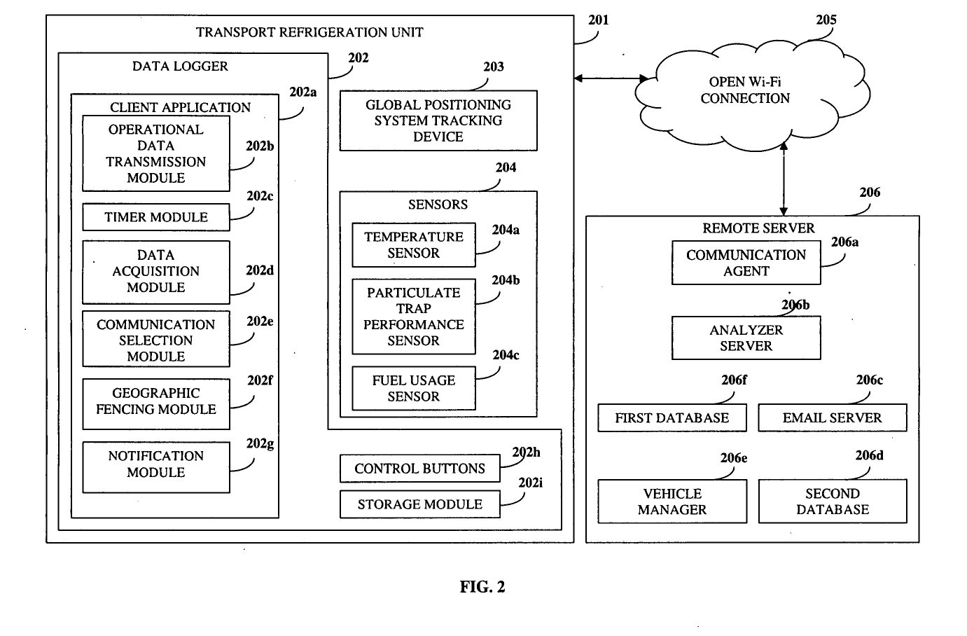

FIG. 1 illustrates a method for position based tracking of operation of a transport refrigeration unit (TRU) 201. The TRU 201 is provided with a data logger 202 as exemplarily illustrated in FIG. 2. In the method disclosed herein, a client application 202a is provided 101 on the data logger 202. A user of the TRU 201 activates the client application 202a on the data logger 202 using one of multiple control buttons 202h provided on the data logger 202. The client application 202a on the data logger 202 communicates with a remote server 206 via wired communication, wireless communication, or a combination thereof. The wireless communication is performed via a communication network, for example, an open or protected wi-fi connection network of a facility where a truck with the TRU 201 is located. The client application 202a is connected to the remote server 206 via, for example, any open wi-fi connection 205. For purposes of illustration, the detailed description refers to any open wi-fi connection 205; however the scope of the method and system disclosed herein is not limited to an open wi-fi connection 205 but may be extended to include any wired or wireless communication networks. The client application 202a selects a mode of communication with the remote server 206 based on user preferences configured on the client application 202a.

A global positioning system (GPS) tracking device 203 on the TRU 201 tracks the position of the TRU 201. The client application 202a determines 102 position data of the TRU 201 with respect to multiple predefined geographic zones, stored on the client application 202a of the data logger 202. The client application 202a checks position data of the TRU 201 to determine if the TRU 201 is within one of the predefined geographic zones defined for a facility, by means of geographic fencing. If the TRU 201 is at a new facility, in one embodiment, the TRU user presses one of the control buttons 202h on the data logger 202 to transmit the position data of the new facility to the remote server 206. The remote server 206 defines a new geographic zone for the new facility and stores the new geographic zone in a first database 206f comprising the predefined geographic zones on the remote server 206. The client application 202a then communicates with the remote server 206 to update the predefined geographic zones stored on the client application 202a of the data logger 202 with the new geographic zone.

Consider an example where a user of the TRU 201 arrives at a new facility that has not been included as a geographic zone in the predefined geographic zones that the TRU 201 operates in. The TRU user has the option of defining a new geographic zone for the new facility. In one embodiment, when the TRU 201 is at the facility, the TRU user presses one of the control buttons 202h to transmit the position of the TRU 201 to the remote server 206 via, for example, a wi-fi connection at the facility. The remote server 206 then defines a new geographic zone for the new facility and stores the new geographic zone in a first database 206f comprising the predefined geographic zones so that when the TRU user returns to the same facility the next time, the client application 202a automatically recognizes that the facility is within the predefined geographic zones. In another embodiment, the TRU user notifies the address of the new facility to the administrator of the first database 206f on the remote server 206. The administrator then defines a new geographic zone for the new facility and stores the new geographic zone in a first database 206f on the remote server 206 comprising the predefined geographic zones. The remote server 206 then communicates with the client application 202a to update the predefined geographic zones stored on the client application 202a of the data logger 202 with the new geographic zone.

The client application 202a acquires 103 operational data of the TRU 201 when the TRU 201 is within the predefined geographic zones stored on the client application 202a. The operational data comprises, for example, the duration for which power was supplied to the TRU 201 in a first mode of operation and in a second mode of operation of the TRU 201, the time when the power was switched from the first mode of operation to the second mode of operation of the TRU 201, duration of the stop of the TRU 201 at a facility, etc. The first mode of operation of the TRU 201 is a diesel mode and the second mode of operation of the TRU 201 is an electric mode. The readings of the duration of operation of the TRU 201 in each of the first mode of operation and the second mode of operation are herein referred to as hour meter readings. The operational data further comprises, for example, data obtained from multiple sensors 204 located within the TRU 201. The data obtained from the sensors 204 comprises, for example, temperature distribution within the TRU 201 at predetermined points in time, performance of a diesel particulate trap located in the TRU 201, usage of diesel fuel by the TRU 201, etc.

The client application 202a transmits the operational data to the remote server 206 when the client application 202a on the TRU 201 has access to the communication network. The client application 202a seeks to establish a wireless connection, for example, a wi-fi (802.11g) connection for transmitting the position data and the operational data to the remote server 206. The client application 202a may be authenticated prior to establishing the wi-fi connection using an authentication code, for example, a password. The client application 202a communicates stored data regarding the position and operating conditions of the TRU 201 to the remote server 206, or stores the data in a storage module 202i, for example, on a storage card on board the TRU 201 depending on the availability of an open wi-fi connection 205. The TRU 201 has the capacity to hold, for example, at least 3 years of information without a single upload.

Consider an example where the client application 202a constantly seeks to establish a connection with a wi-fi network for transmitting the position data and the operational data to the remote server 206. The position data and the operational data from the data logger 202 are uploaded to the remote server 206 when a wi-fi connection is established. If the wi-fi network is web protected, the client application 202a logs in to the wi-fi network using, for example, the password configured on the client application 202a. If the password is not configured on the client application 202a, the TRU user configures the password on the client application 202a and uses the password to connect to the wi-fi network. Therefore, if the TRU 201 is parked at a delivery spot, for example, a restaurant, the data logger 202 uploads the position data and the operational data from the TRU 201 to the remote server 206 via the open wi-fi connection 205.

The client application 202a notifies 104 a user of the TRU 201 regarding control of the operating conditions of the TRU 201 based on the position data and the operational data. The client application 202a notifies the user of the TRU 201 when the duration of a stop at a facility exceeds an allowable duration of stop, and when duration of operation of the TRU 201 in the first mode of operation, that is, the diesel mode exceeds an allowable duration of operation. When the duration of operation of the TRU 201 in the first mode of operation, that is, the diesel mode exceeds the allowable duration of operation, the client application 202a notifies the TRU user to switch the mode of operation of the TRU 201 from the first mode of operation to the second mode of operation, that is, to the electric mode of the TRU 201. The TRU user is notified, for example, by running an alarm in the TRU 201 to alert the user to shift the mode of operation to the electric mode, or by sending an electronic mail (email) or a short message service (SMS) text message to the TRU user.

Control of the operating conditions of TRU 201 based on the position data and the operational data ensures compliance of the user of the TRU 201 with TRU airborne toxic control measures (ATCM). TRUs 201 equipped with electric standby (E/S) or hybrid electric TRUs 201 operating in California can qualify to meet the ultra low emission TRU (ULETRU) performance standard as alternative technology only if they comply with the in-use performance standards of the TRU airborne toxic control measure (ATCM) as an alternative technology.

FIG. 2 exemplarily illustrates a system for position based tracking of operation of a TRU 201. The system disclosed herein comprises a data logger 202, a global positioning system (GPS) tracking device 203, multiple sensors 204 connected to a remote server 206 via an open wi-fi connection 205. The data logger 202, the GPS tracking device 203, and the sensors 204 are provided on the TRU 201.

The data logger 202 comprises a client application 202a, multiple control buttons 202h, and a storage module 202i. The TRU user uses the control buttons 202h for activating the client application 202a on the data logger 202. The client application 202a comprises an operational data transmission module 202b, a timer module 202c, a data acquisition module 202d, a communication selection module 202e, a geographic fencing module 202f, and a notification module 202g. The communication selection module 202e selects the mode of communication with the remote server 206 based on user preferences configured on the client application 202a. For example, the communication selection module 202e selects the wi-fi or GPRS mode of communication based on the TRU user preferences.

The GPS tracking device 203 determines the position data of the TRU 201 with respect to multiple predefined geographic zones stored on the geographic fencing module 202f on the client application 202a. The GPS tracking device 203 located on the TRU 201 provides position data of the TRU 201 to the geographic fencing module 202f. The data acquisition module 202d acquires operational data of the TRU 201 when the TRU 201 is within the predefined geographic zones.

The geographic fencing module 202f checks the position data of the TRU 201 to determine if the TRU 201 is within one of the predefined geographic zones defined for a facility. If the TRU 201 is at a new facility, the geographic fencing module 202f transmits position data of the new facility to the remote server 206. The remote server 206 defines a new geographic zone for the new facility and stores the new geographic zone in a first database 206f comprising the predefined geographic zones. The geographic fencing module 202f communicates with the remote server 206 to update the predefined geographic zones stored on the client application 202a of the data logger 202 with the new geographic zone.

The timer module 202c monitors the time of switching between a first mode of operation, that is, the diesel mode, and a second mode of operation, that is, the electric mode of the TRU 201. The timer module 202c also monitors the duration of operation of the TRU 201 in the diesel mode and the electric mode, and the duration of the stop of the TRU 201 at each facility.

The data acquisition module 202d obtains data from the sensors 204 located within the TRU 201. The sensors 204 comprise, for example, a temperature sensor 204a, a particulate trap performance sensor 204b, a fuel usage sensor 204c, etc. The temperature sensor 204a obtains the temperature distribution within the TRU 201 at predetermined points in time. The particulate trap performance sensor 204b obtains performance of the diesel particulate trap located in the TRU 201 so that when the diesel particulate trap is clogged, an alert is sent to the user of the TRU 201 to service the diesel particulate trap, for example, by sending an email to the TRU user. The fuel usage sensor 204c obtains the diesel fuel usage data of the TRU 201. The storage module 202i located within the data logger 202 stores the data obtained from the multiple sensors 204.

The operational data transmission module 202b transmits the operational data of the TRU 201 to the remote server 206 when the client application 202a on the TRU 201 has access to an open wi-fi connection 205. The position data and the operational data are stored in the first database 206f of the remote server 206.

The notification module 202g notifies a user of the TRU 201 regarding control of operating conditions of the TRU 201 based on the position data and the operational data. The notification module 202g notifies the TRU user when the duration of a stop at the facility exceeds an allowable duration of a stop. The notification module 202g also notifies the user of the TRU 201 to switch from the first mode of operation to the second mode of operation when duration of operation in the first mode of operation exceeds an allowable duration of operation.

The remote server 206 communicates with the client application 202a via wired communication, wireless communication, or a combination thereof. The wireless communication is performed via a wi-fi protocol or a GPRS protocol. The remote server 206 comprises a communication agent 206a, an analyzer server 206b, an email server 206c, the first database 206f, a second database 206d, and a vehicle manager 206e.

The communication agent 206a receives connection requests from the client application 202a, maintains connection between the remote server 206 and the data logger 202, performs basic package processing for the data uploaded by the data logger 202, and sends command or reply data to the data logger 202 directly. The email server 206c sends an email to a designated email address of the TRU user. The first database 206f stores the data received from the communication agent 206a. The first database 206f, for example, a structured query language (SQL) database also communicates data with the client application 202a on a first TRU 201 regarding the position of other TRUs 201 present at the same facility at the same time as the first TRU 201. When the client application 202a of the first TRU 201 is notified regarding the presence of more than two TRUs 201 at the same location as the first TRU 201, the client application 202a on the first TRU 201 checks to determine if the first TRU 201 is operating under diesel power and starts the timer for logging the diesel hours if the first TRU 201 is using diesel power. The notification module 202g notifies the user of the first TRU 201 to switch the diesel mode of operation of the first TRU 201 to electric standby mode of operation, even if duration of the diesel mode of operation of the first TRU 201 is less than the allowable duration of operation, to ensure compliance of the first TRU 201 with the TRU ATCM.

The second database 206d processes data exchange between the client application 202a and the first database 206f. The vehicle manager 206e adds vehicle information and administrator group information. The analyzer server 206b analyzes data transmitted by the geographic fencing module 202f for storing a new geographic zone in the first database 206f comprising multiple predefined geographic zones.

The method and system disclosed herein ensures that the TRU diesel engine use is eliminated at all facilities, with narrow exceptions such as during an emergency, during normal ingress and egress yard maneuvering, and to make short duration stops to unload refrigerated goods at restaurants, grocery and convenience stores, and similar facilities provided the delivery stay is not more than 30 minutes, and no more than two TRUs 201 are present at a time. The method and system disclosed herein maintains a robust recordkeeping system to demonstrate diesel engine operation is eliminated when the TRU 201 stops at a facility. The records to be maintained to demonstrate compliance comprise, for example, gate time stamps or logs at each facility gate entry and exit during arrival and departure, engine hour meter readings at each entry and exit, E/S hour meter readings at each entry and exit, diesel fuel consumption records for each unit, and temperature compliance of the TRU 201 with regard to the transported goods. The method and system disclosed herein therefore ensures compliance of the TRU user with TRU ATCM.

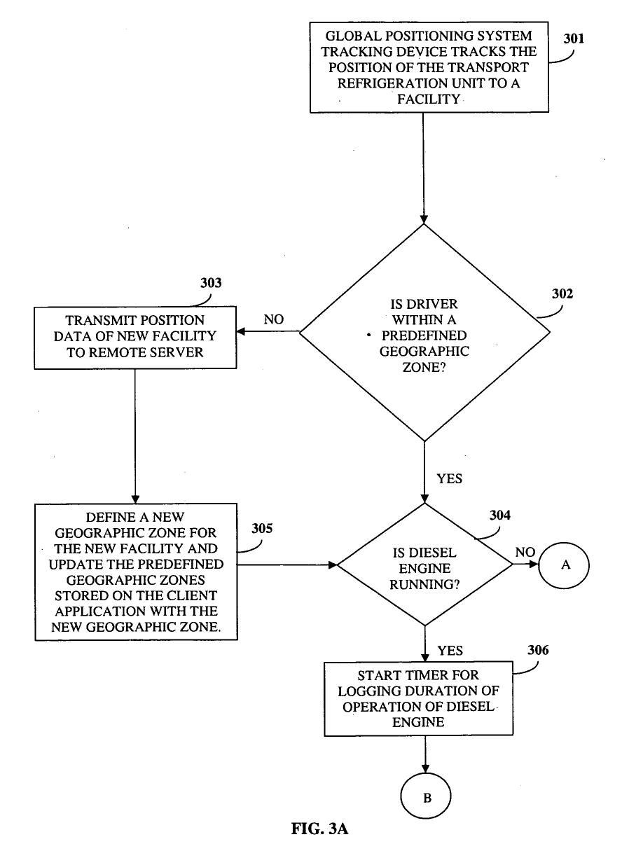

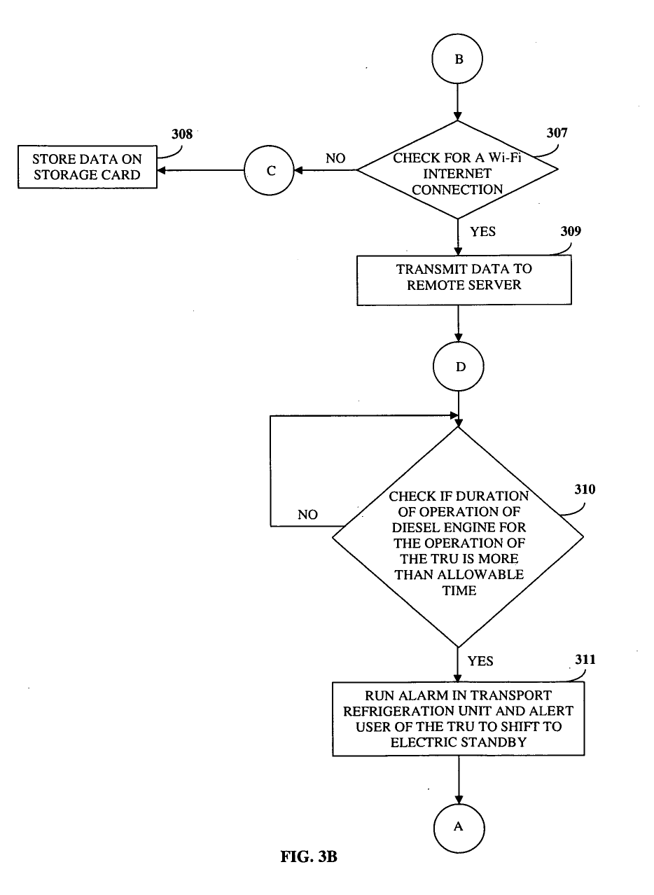

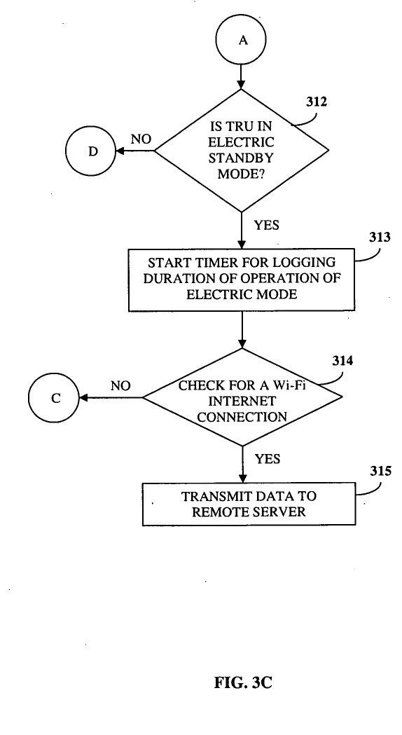

FIGS. 3A-3C exemplarily illustrate a flowchart comprising the steps involved in tracking operation of the TRU 201 and alerting the user regarding control of the operating conditions of the TRU 201. The GPS tracking device 203 tracks 301 the position of the TRU 201 to a facility and checks 302 if the driver is within a predefined geographic zone. If the driver is not in the known facility in the predefined geographic zone, the client application 202a transmits 303 position data of the new facility to the remote server 206. The remote server 206 defines 305 a new geographic zone for the new facility and updates the predefined geographic zones stored on the client application 202a with the new geographic zone. If the driver is in a predefined geographic zone, or if a new geographic zone has been defined for the new facility, the client application 202a checks 304 if the diesel engine for the operation of the TRU 201 is running and starts 306 the timer for logging the duration of operation of the diesel engine if the diesel engine is being used.

The client application 202a then checks 307 for a wi-fi internet connection, and transmits 309 data to the remote server 206 if the client application 202a detects the wi-fi internet connection. If the wi-fi internet connection is not found, the client application 202a stores 308 the data in the storage module 202i, for example, on a storage card on the data logger 202. The client application 202a then continuously checks 310 if the duration of operation of the diesel engine for the operation of the TRU 201 is more than an allowable duration until the duration has reached the value of the allowable duration. If the duration exceeds the allowable duration, an alarm is run 311 in the TRU 201 to alert the TRU user to shift power for the TRU 201 to electric standby. In one embodiment, for example, an email is sent to the TRU user to alert the TRU user to shift to the electric standby.

If the diesel engine is not being used 304 or if the alarm 311 has been run in the TRU 201 to alert the user to shift to electric standby, the client application 202a checks 312 if TRU 201 is in electric mode of operation. If the TRU 201 is not in an electric standby, then the client application 202a goes back to the step of checking 310 if the duration of operation of the diesel engine is more than the allowable time. If the TRU 201 is operating in an electric mode, the client application 202a starts 313 a timer for logging duration of operation of TRU 201 in electric mode. The client application 202a then checks 314 for a wi-fi internet connection and stores 308 the data in the storage module 202i, for example, on a storage card if the client application 202a does not detect a wi-fi internet connection. If a wi-fi internet connection is detected, the client application 202a transmits 315 data to the remote server 206.

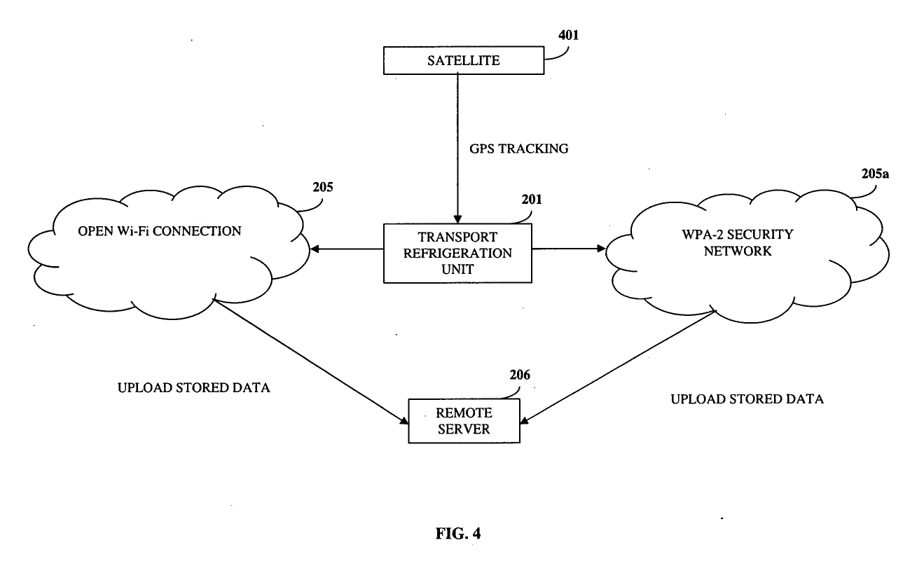

FIG. 4 exemplarily illustrates a user of a TRU 201 communicating with a remote server 206 from different communication networks for uploading stored data. A GPS tracking device 203 tracks the position of the TRU 201 with the help of a satellite 401. The TRU user configures the client application 202a to upload stored data to remote server 206 when the TRU 201 is in a home network, for example, a wi-fi protected access (WPA) 2 security network 205a. Consider for example, a TRU user drives the TRU 201 to an outlet having an open wi-fi connection 205 outside the WPA 2 security network 205a that uses the same wireless package that the user uses in the WPA 2 security network 205a. The TRU user can then upload stored data to the remote server 206 by logging on to an open wi-fi connection 205 using the username and password for the user's home network 205a.

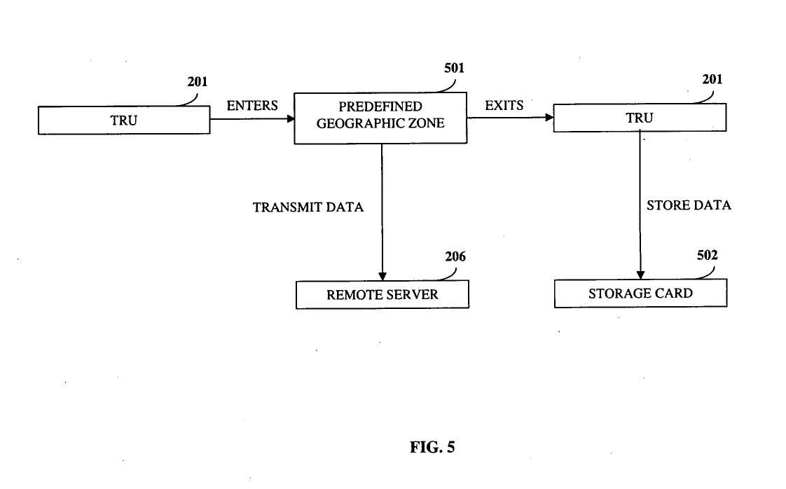

FIG. 5 exemplarily illustrates data storage and transmission of a TRU 201 while the TRU 201 enters and exits a predefined geographic zone 501. When the TRU 201 enters a predefined geographic zone 501, the client application 202a of the TRU 201 transmits data directly to the remote server 206 if the client application 202a has access to a communication network. When the TRU 201 exits the predefined geographic zone 501 outside the communication network, the data is stored on a storage card 502 on the TRU 201.

When a TRU user uses, for example, a secure digital (SD) card as a mode of data storage on the TRU 201, the TRU user benefits from, for example, the absence of monthly fees, memory storage for up to 10 years of logging, lack of maintenance requirements, and option for temperature record keeping. If the user is using a public or private wi-fi network, the benefits comprise, for example, the possible absence of monthly fees, ability to use with fleets of 50 or more units, ability to upload when public wi-fi is available, and ability to use owners' existing network and office computer. When the TRU user uses GPRS, the benefits comprise, for example, real time monitoring, SMS text is available as an option with monthly phone plans of about $10 dollars a month, the ability to track the TRU 201, ability to SMS text owner when shutdown code occurs, ability to SMS text owner when diesel operation is over predetermined time, for example, 30 minutes, option to notify owner of particulate trap cleaning requirement, usage of over the air updates and commands, ability to SMS text diagnostic aid, and 24 hours website access.

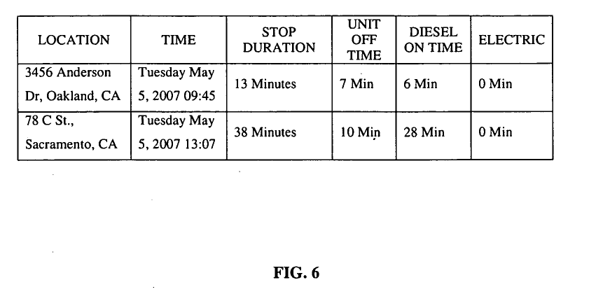

FIG. 6 exemplarily illustrates records in a first database 206f of the remote server 206, corresponding to tracking the mode of operation of a TRU 201 at two facilities. When the TRU 201 enters a predefined geographic zone, the data logger 202 logs the diesel run time. When the TRU 201 shuts off, the data logger 202 logs that data in that geographic zone. Therefore, the data logger 202 logs the diesel off time and diesel run time while in that particular geographic zone.

Consider for example a user of the TRU 201, for example, Bill who drives a TRU 201 to 3456 Anderson Drive in Oakland, Calif. on Tuesday, May 5 2007 at 09:45 and remains at the location for 13 minutes. The timer module 202c monitors the usage of the two modes of operation of the TRU 201 while Bill is in the facility and stores the hour meter readings as a record in the first database 206f of the remote server 206. The “Location” column of the table gives the location information of the TRU 201. The column “Time” stores time of arrival of the TRU 201. The “Stop Duration” column stores the data regarding the duration of stop at the facility. The “Unit off time” column shows the duration of time when the TRU 201 is not using the diesel mode of operation. The columns under “Diesel on time” and “Electric” show the time of operation of the TRU 201 under the diesel mode of operation and the electric mode of operation respectively.

The first row shows that Bill reached 3456, Anderson Drive in Oakland, Calif. on Tuesday, May 5 2007 at 09:45 and was at the facility for a total of 13 minutes. The TRU 201 was operating in the diesel mode for 6 minutes and remained at the facility with the diesel engine shut off for 7 minutes. The electric mode of operation was not used and hence shows a value of zero. Similarly, when Bill goes to 78 C Street in Sacramento, Calif., the record shows that Bill reached the location at 13:07 on Tuesday, May 5 2007 and remained at the location for a total of 38 minutes. While Bill was at the location, he used the diesel engine for 10 minutes and shut off the diesel mode of operation for 28 minutes.

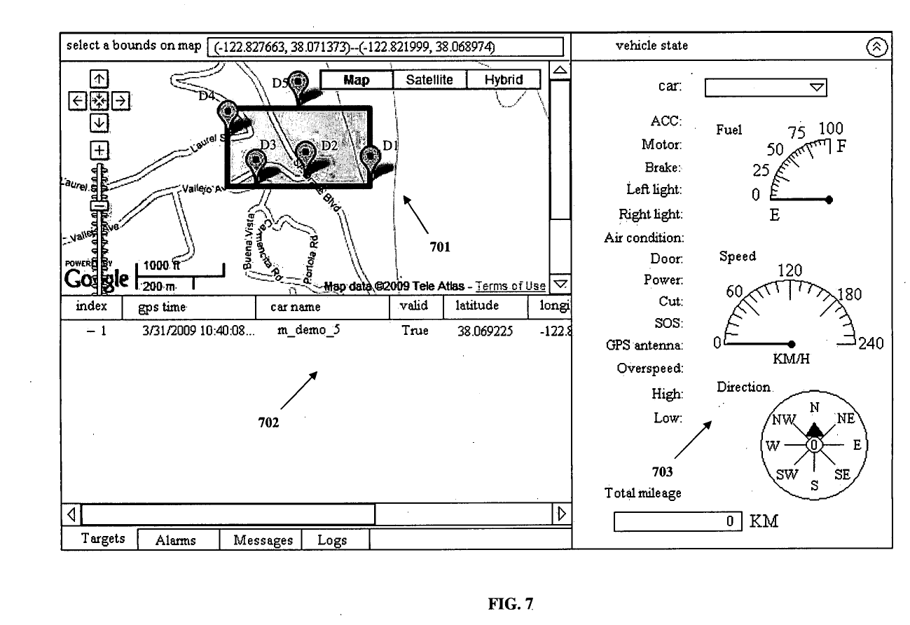

FIG. 7 exemplarily illustrates a geographic zone having multiple loading and unloading docks. The highlighted rectangular area in the map zone 701 represents a predefined geographic zone. In this example, the geographic zone comprises 5 different loading and unloading docks that can be used by a TRU 201 to load or unload goods. The map pins D1, D2, D3, D4, and D5 represent the different loading and unloading docks.

The table 702 below the map shows, for example, the registered name of the TRU user, the current time, and the current position of the TRU user with respect to a predefined geographic zone. The column under “index” shows the number corresponding to the TRU 201 registered by a TRU user. The column under “GPS time” shows the current time. The column under “car name” shows the registered name of the TRU user. The column under “valid” shows whether the TRU user is within a predefined geographic zone or not. The column under “latitude” shows the latitude on which the TRU 201 is currently positioned. The column under “longitude” shows the longitude on which the TRU 201 is currently positioned.

The vehicle state section 703 of FIG. 7 shows information regarding the TRU 201. A drop down text box allows the user to select the TRU 201 that the user wants to monitor, from a list. Different data regarding the operation of a TRU 201 are shown for the TRU 201 that is selected from the drop down text box. The displayed data comprises, for example, ACC, motor, brake status, left and right light status, air condition status, door open/close indicator, power, cut, SOS signals, GPS antenna reception, over speed indicator, high or low signal indicator, vehicle mileage indicator, fuel tank monitor, speedometer, and a compass to display the direction where the TRU 201 is heading.

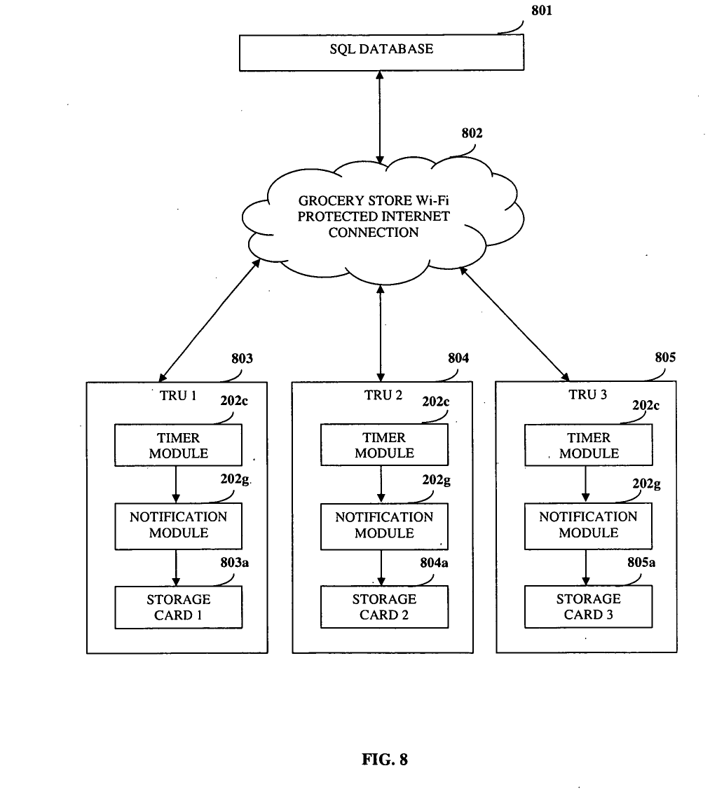

FIG. 8 exemplarily illustrates tracking of a diesel hour meter of the TRUs, for example, TRU 1 803, TRU 2 804, and TRU 3 805 when more than one TRU 201 is present at a grocery store at the same time. A first database 206f on the remote server 206, for example, an SQL database 801 communicates with TRU 1 803, TRU 2 804, and TRU 3 805 through the grocery store wi-fi protected internet connection network 802. When TRU 1 803, TRU 2 804, and TRU 3 805 are present at the grocery store at the same time, the SQL database 801 notifies the client application 202a on TRU 1 803, TRU 2 804, and TRU 3 805 through the grocery store wi-fi protected internet connection network 802. The client application 202a on TRU 1 803 initiates a timer module 202c to log the duration of operation of the TRU 1 803 in the diesel mode of operation if the diesel engine power is being utilized to operate TRU 1 803. When the duration of diesel mode of operation exceeds an allowable duration, the user of TRU 1 803 is notified by the notification module 202g to switch the diesel mode of operation of TRU 1 803 to electric standby mode of operation. The data regarding the duration of the diesel mode of operation and time of switching between the diesel mode of operation and electric mode of operation of TRU 1 803 is stored in the storage module 202i, for example, on a storage card 1 803a. Similarly, the client application 202a on each of TRU 2 804 and TRU 3 805 also checks for diesel mode of operation, monitors duration of diesel operation, notifies users of TRU 2 804 and TRU 3 805 to switch to electric standby mode, and store the operational data on the storage card 2 804a on TRU 2 804 and the storage card 3 805a on TRU 3 805 respectively.

Facilities subject to TRU ATCM are required to submit a one-time report to the ARB. Three reporting forms are required and the reporting forms can be downloaded from the TRU website. The reporting forms are business forms, facility reporting forms, and TRU inventory forms. The facilities that do not track TRU engine run time at facilities have an option of setting up recordkeeping systems to collect the TRU engine run time data. TRU engine hour meter readings are taken when each unit enters and leaves the facility gates. The records comprise the date, whether the TRU 201 was entering or leaving the facility, and whether the TRU 201 included refrigerated goods or not. Based on the engine hour meter readings for each load, the TRU engine run time that occurred at the facility is calculated.

Certain facilities may qualify to use ARB approved alternative recordkeeping and calculation procedures for tracking TRU engine run time at facilities. For inbound refrigerated loads, if some TRU users are not allowed to take engine hour meter readings due to vendor procedures, facilities then use gate time stamps or check in and departure times. Engine hour meter readings are taken where possible. If the TRU users do not know how to read the engine hour meter, the facility obtains hour meter reading procedures from TRU manufacturers and provides instructions to the TRU user. Where engine hour meter readings are not possible and gate time stamps or check in and departure times are used, the engines are assumed to operate all of the time.

Consider an example where a TRU user goes to a McDonalds® outlet to drop off food to a customer. The driver has not had access to a wi-fi connection for 3 days. When the user pulls in at the parking lot, the client application 202a establishes a wi-fi connection with the McDonalds router to connect to the remote server 206. The data from the past 3 days is automatically uploaded to the first database 206f on the remote server 206. The upload will take, for example, 45 seconds. If the client application 202a loses connection with the remote server 206, the client application 202a simply checks again for wi-fi availability until the connection is re-established with the remote server 206. The storage module 202i on the data logger 202 will have the capacity to hold at least 3 years of information without a single upload.

Consider an example where a TRU user Joe takes a lunch break at a McDonalds outlet in the locality where he works. When the TRU 201 pulls in at the parking lot in McDonalds, the client application 202a on the data logger 202 of the TRU 201 tries to establish a connection with the wi-fi router in the McDonalds outlet. The wi-fi router in McDonalds provides, for example, a wi-fi network only within 300 feet of the router. When the router receives a connection request from the client application 202a on the TRU 201, the wi-fi router requests for a password to log on to the wi-fi network. The client application 202a then communicates the password stored in the storage module 202i on the data logger 202, to the wi-fi router. The wi-fi router then processes the password, accepts the password, and sends a dynamic host configuration protocol (DHCP) internet protocol to the client application 202a. The client application 202a accepts the DHCP internet protocol (IP) and uses the DHCP IP to connect to the wi-fi network. When the wi-fi connection is established, the client application 202a uploads the data, for example, the hour meter readings, the diesel engine runtime, temperature data, fuel usage, etc., stored in the storage module 202i, for example, on a storage card of the data logger 202 to the remote server 206.

Consider an example where a TRU user uses the system disclosed herein for the first time. A TRU technician installs the system on a TRU 201. The TRU user receives a special logon password to a website hosted on the remote server 206. The TRU user then puts in the user's contact information on the website. The user will then be directed to a screen instructing the user to place the TRU 201 near an open wi-fi spot. The TRU user then sets up a username and password for all the wi-fi spots that the TRU user has access to. Consider for example, the TRU user has an American telephone & telegraph (AT&T) digital subscriber line (DSL) service. The TRU user can access all the open wi-fi networks that run on the AT&T DSL service, for example, McDonalds wi-fi spots and Starbucks wi-fi spots. When the TRU user uses the diesel mode of operation for the TRU 201, a simple high or low signal is created by one of the sensors 204. The data acquisition module 202d receives the signal from the sensor and a timer starts to monitor the diesel engine runtime. When the signal goes high or low again, the timer stops and the diesel engine runtime data is stored in the storage module 202i, for example, on a storage card on the data logger 202. The electric mode of operation also follows a similar process. The operational data transmission module 202b transmits the stored data to the remote server 206 when the client application 202a has access to an open wi-fi connection 205.

Consider an example where the TRU 201 does not have access to a communication network. Position data and operational data of the TRU 201 will be stored in a storage module 202i, for example, on a storage card on the data logger 202. The storage card can be removed for download. The storage module 202i will only, for example, log binary information. When a wi-fi connection is established, the stored binary information is uploaded to the first database 206f on the remote server 206. The first database 206f recognizes that the uploaded information is not live data because, for example, the packet serial number is different for each record stored on the storage module 202i or the first database 206f.

Consider a TRU user, for example, Chris. Chris regularly delivers refrigerated goods to 2 facilities. An area in facility 1 having, for example, a radius of 600 ft is defined as the geographic zone for facility 1. A radius of 600 ft is given to cover all the loading and unloading docks in facility 1. An area in facility 2 having, for example, a radius of 2000 ft. is defined as the geographic zone for facility 2. Facility 2 is, for example, a much larger facility with more loading/unloading docks. Chris starts the day by delivering refrigerated goods to facility 1. The timer monitoring the diesel engine runtime on Chris' TRU 201 starts only when TRU 201 reaches the geographic zone within facility 1. The diesel engine runtime timer starts when Chris enters the geographic zone. If Chris does not shift to the electric standby option when he is loading or unloading the refrigerated goods, then after 30 minutes of diesel engine runtime, an alarm is sounded on the TRU 201, or an SMS text message is sent to Chris when there is an open wi-fi connection 205 at the facility, reminding Chris to use the electric standby mode.

After Chris has finished loading/unloading in facility 1 and leaves the geographic zone to go to facility 2, the timer stops monitoring his diesel engine runtime. The diesel engine runtime of the TRU 201 is not timed while Chris is driving from facility 1 to facility 2. Whether Chris reaches facility 2 in 10 minutes or 50 minutes, the timer does not monitor the diesel engine runtime as Chris is outside either of the two predefined geographic zones. Only when Chris enters the geographic zone within facility 2, the diesel engine runtime is monitored again. When Chris enters the geographic zone in facility 2, the timer starts monitoring the diesel engine runtime and alerts Chris if the diesel engine has been running for more than 30 minutes while he is within the geographic zone in facility 2.

Consider an example where a vendor's TRU 201 enters the facility to deliver refrigerated goods to the distribution and an engine hour meter is taken. The TRU 201 leaves after unloading and an engine hour meter reading is taken. The entry and exit engine hour meter readings would be used to determine the TRU engine operating time for the inbound load and this time would be used in the calculation of average TRU engine operating time per inbound refrigerated load.

Consider an example where a TRU 201 enters a facility with dry-goods-only load and an engine hour meter reading is taken. If the TRU 201 is not used for cold storage between entry and exit, then engine hour meter readings are disregarded and not used in calculation of TRU engine operating time or averages. If the TRU 201 is used for cold storage while at the facility then engine hour meter readings only apply accrual of cold storage TRU engine operating time. Engine hour meter readings would not be used in calculation of average TRU engine operating time at the facility.

Consider an example where a TRU 201 enters a facility with a dry-goods-only load and an engine hour meter reading is taken. The TRU 201 leaves loaded with refrigerated goods and an engine hour meter reading is taken. If the TRU 201 is not used for cold storage between entry and exit, then the engine hour meter readings would be used to determine the TRU engine operating time for an outbound load and the time would be used in the calculation of average TRU engine operating time per outbound refrigerated load. If the TRU 201 is used for cold storage while at the facility, then an intermediate engine hour meter would be required at the end of cold storage operation. The entry engine hour meter reading and intermediate engine hour meter reading would apply to accrual of cold storage TRU engine operating time. The intermediate engine hour meter reading and exit engine hour meter reading would be used to determine the TRU engine operating time for an outbound load and the time used in the calculation of average TRU engine operating time per outbound refrigerated load.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer-readable medium” refers to any medium that participates in providing data, for example instructions that may be read by a computer, a processor, or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically constitutes the main memory. Transmission media include coaxial cables, copper wire, and fiber optics, including the wires that comprise a system bus coupled to the processor. Common forms of computer-readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the first database 206f and the second database 206d, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, Sun® processors, IBM® processors, etc. that are adapted to communicate with the computer. Any number and type of machines may be in communication with the computer.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method for position based tracking of operation of a transport refrigeration unit, comprising the steps of:
providing a client application on a data logger connected to said transport refrigeration unit;
determining position data of the transport refrigeration unit with respect to a plurality of predefined geographic zones stored on said client application of said data logger;
acquiring operational data of the transport refrigeration unit by the client application when the transport refrigeration unit is within said predefined geographic zones; and
notifying a user of the transport refrigeration unit by the client application regarding control of operating conditions of the transport refrigeration unit based on said position data and said operational data;
whereby said control of said operating conditions of the transport refrigeration unit based on the position data and the operational data ensures compliance of said user of the transport refrigeration unit with transport refrigeration unit airborne toxic control measures.

2. The method of claim 1, wherein the operational data comprises:
time of switching between a first mode of operation and a second mode of operation of the transport refrigeration unit, wherein said first mode of operation is a diesel mode and said second mode of operation is an electric mode;
duration of operation of the transport refrigeration unit in each of the first mode of operation and the second mode of operation, and duration of stop of the transport refrigeration unit at a facility; and
data obtained from a plurality of sensors located within the transport refrigeration unit.

3. The method of claim 2, wherein said data obtained from said sensors comprises:
temperature distribution within the transport refrigeration unit at predetermined points in time;
performance of a diesel particulate trap located in the transport refrigeration unit; and
usage of diesel fuel by the transport refrigeration unit.

4. The method of claim 1, wherein said step of notifying the user comprises the steps of:
notifying the user when a duration of stop exceeds an allowable duration of stop at a facility; and
notifying the user to switch from a first mode of operation to a second mode of operation when duration of operation in said first mode of operation exceeds an allowable duration of operation, wherein the first mode of operation is a diesel mode and said second mode of operation is an electric mode.

5. The method of claim 1, further comprising the steps of:
checking said position data of the transport refrigeration unit to determine if the transport refrigeration unit is within one of the predefined geographic zones defined for a facility;
transmitting position data of a new facility to a remote server, if the transport refrigeration unit is at said new facility, wherein said remote server defines a new geographic zone for the new facility and stores said new geographic zone in a first database comprising the predefined geographic zones; and
communicating with the remote server to update the predefined geographic zones stored on the client application of the data logger with the new geographic zone.

6. The method of claim 1, wherein the operational data is transmitted to a remote server when the client application on the transport refrigeration unit has access to a communication network.

7. The method of claim 1, wherein the client application on the data logger communicates with a remote server via one of wired communication, wireless communication, and a combination thereof, wherein said wireless communication is performed via one of a wi-fi protocol and a general packet radio service protocol.

8. The method of claim 1, wherein the client application selects a mode of communicating with a remote server based on user preferences configured on the client application.

9. The method of claim 1, wherein the user activates the client application on the data logger using one of a plurality of control buttons provided on the data logger.

10. The method of claim 1, wherein the client application seeks to establish a wi-fi connection for transmitting the position data and the operational data to the remote server, wherein the client application is authenticated prior to establishing said wi-fi connection.

11. A system for position based tracking of operation of a transport refrigeration unit, comprising:
a global positioning system tracking device for determining position data of said transport refrigeration unit with respect to a plurality of predefined geographic zones stored on a geographic fencing module on a client application provided on a data logger connected to the transport refrigeration unit; and
said client application comprising:
a data acquisition module for acquiring operational data of the transport refrigeration unit when the transport refrigeration unit is within said predefined geographic zones; and
a notification module for notifying a user of the transport refrigeration unit regarding control of operating conditions of the transport refrigeration unit based on said position data and said operational data;
whereby said control of said operating conditions of the transport refrigeration unit based on the position data and the operational data ensures compliance of said user of the transport refrigeration unit with transport refrigeration unit airborne toxic control measures.

12. The system of claim 11, wherein the client application further comprises a timer module for monitoring one or more of:
time of switching between a first mode of operation and a second mode of operation of the transport refrigeration unit, wherein said first mode of operation is a diesel mode and said second mode of operation is an electric mode;
duration of operation of the transport refrigeration unit in each of the first mode of operation and the second mode of operation; and
duration of stop of the transport refrigeration unit at a facility.

13. The system of claim 11, wherein said data acquisition module obtains data from a plurality of sensors located within the transport refrigeration unit.

14. The system of claim 13, wherein said sensors comprise:
a temperature sensor for obtaining temperature distribution within the transport refrigeration unit at predetermined points in time;
a particulate trap performance sensor for obtaining performance of a diesel particulate trap located in the transport refrigeration unit; and
a fuel usage sensor for obtaining diesel fuel usage data of the transport refrigeration unit.

15. The system of claim 11, further comprising a remote server for communicating with the client application on said data logger via one of wired communication, wireless communication, and a combination thereof, wherein said wireless communication is performed via one of a wi-fi protocol and a general packet radio service protocol.

16. The system of claim 15, wherein said remote server further comprises:
a communication agent for receiving connection requests from the client application on the data logger, maintaining connection between the remote server and the data logger, basic package processing for the data uploaded by the data logger, sending one of command and reply data to the data logger directly;
an analyzer server for analyzing data transmitted by said geographic fencing module for storing a new geographic zone in a first database comprising a plurality of predefined geographic zones;
an email server for sending an electronic mail to a designated electronic mail address of the user of the transport refrigeration unit;
said first database to store data received from said communication agent;
a second database for processing data exchange between the client application and the first database; and
a vehicle manager for adding vehicle information and administrator group information.

17. The system of claim 11, wherein the client application further comprises an operational data transmission module for transmitting the operational data to a remote server when the client application on the transport refrigeration unit has access to a communication network.

18. The system of claim 11, wherein the client application further comprises a communication selection module for selecting mode of communicating with a remote server based on user preferences configured on the client application.

19. The system of claim 11, wherein said geographic fencing module performs the steps of:
checking said position data of the transport refrigeration unit to determine if the transport refrigeration unit is within one of the predefined geographic zones defined for a facility;
transmitting position data of a new facility to a remote server, if the transport refrigeration unit is at said new facility, wherein said remote server defines a new geographic zone for the new facility and stores said new geographic zone in a first database comprising the predefined geographic zones; and
communicating with the remote server to update the predefined geographic zones stored on the client application of the data logger with the new geographic zone.

20. The system of claim 11, wherein said notification module performs one or more of:
notifying the user of the transport refrigeration unit when duration of stop at a facility exceeds an allowable duration of stop; and
notifying the user of the transport refrigeration unit to switch from a first mode of operation to a second mode of operation when duration of operation in said first mode of operation exceeds an allowable duration of operation, wherein the first mode of operation is a diesel mode and said second mode of operation is an electric mode.

21. The system of claim 11, wherein said data logger comprises a plurality of control buttons for activating the client application on the data logger.

22. The system of claim 11, wherein said data logger further comprises a storage module for storing data obtained from a plurality of sensors located on the transport refrigeration unit.

23. A computer program product comprising computer executable instructions embodied in a computer readable medium, wherein said computer program product comprises:
a first computer parsable program code for providing a client application on a data logger connected to a transport refrigeration unit, wherein said client application on said data logger communicates with a remote server via one of a wired communication, a wireless communication, and a combination thereof;
a second computer parsable program code for determining position data of said transport refrigeration unit with respect to a plurality of predefined geographic zones stored on the client application of the data logger;
a third computer parsable program code for acquiring operational data of the transport refrigeration unit by the client application when the transport refrigeration unit is within said predefined geographic zones; and
a fourth computer parsable program code for notifying a user of the transport refrigeration unit by the client application regarding control of operating conditions of the transport refrigeration unit based on said position data and said operational data.

24. The computer program product of claim 23, further comprising:
a fifth computer parsable program code for checking said position data of the transport refrigeration unit to determine if the transport refrigeration unit is within one of the predefined geographic zones defined for a facility;
a sixth computer parsable program code for transmitting position data of a new facility to said remote server, if the transport refrigeration unit is at said new facility, wherein the remote server defines a new geographic zone for the new facility and stores said new geographic zone in a first database comprising the predefined geographic zones; and
a seventh computer parsable program code for communicating with the remote server to update the predefined geographic zones stored on the client application of the data logger with the new geographic zone.
